(19) United States
(12) Patent Application Publication
(10) Pub. No.: US 2004/0172437 A1
(43) Pub. Date: Sep. 2, 2004

(54) Image processing device and image processing method

(76) Inventors: Makoto Ogawa, Tokyo (JP); Tadashi Shibata, Tokyo (JP)

Correspondence Address: KENYON & KENYON, 1500 K STREET, N.W., SUITE 700, WASHINGTON, DC, 20005, US

(21) Appl. No.: 10/777,662

(22) Filed: Feb. 13, 2004

(30) Foreign Application Priority Data
Feb. 14, 2003 (JP) 2003-036764

(51) Int. Cl. G06F 7/32

(52) U.S. Cl. 708/520

(57) ABSTRACT

Computation is performed by a row computation section to pixel data stored in a first memory cell in a memory unit in a specified column, and a computed result thereof is stored in a second memory cell. Subsequently, computation is performed by a column computation section for the processing data stored in a second memory cell in a memory unit in a specified row, a computed result thereof is stored in a third memory cell, and based on the computed result, filtering is performed.

### CROSS-REFERENCE TO RELATED APPLICATIONS

This application is based upon and claims the benefit of priority from the prior Japanese Patent Application No. 2003-036764, filed on Feb. 14, 2003, the entire contents of which are incorporated herein by reference.

### BACKGROUND OF THE INVENTION

1. [Field of the Invention]

This invention relates to an image processing device and an image processing method to perform image conversion, image enhancement, and the like by carrying out a predetermined processing to a two-dimensional image.

2. [Description of the Related Art]

Conventionally, image conversion, image enhancement, and other processing of a two-dimensional image are performed in such a manner that, for each pixel, data of a plurality of pixels surrounding that pixel are processed one by one.

Specifically, as shown in FIG. 7, each of the large number of pixels 101 arranged in the form of matrix corresponding to a two-dimensional image, for example, data X₁ to X₈ of eight neighboring pixels 102 surrounding a pixel 101 and datum X₀ of the pixel 101 itself, within a kernel block, are corresponded to and multiplied by respective coefficients A₀ to A₈, and a sum of A₀X₀+A₁X₁+. . . +A₈X₈, is obtained as a processing data of the pixel 101. The above series of operations are performed for each of all necessary pixels by shifting the kernel to each pixel.

However, the above-described image processing method, in which computation processing is performed for each of all necessary pixels, results in extremely large volume of computations and extremely high computational burden and power consumption. More specifically, in each time the computation processing is performed, a necessary pixel data has to be transferred from a memory to a processor, and all data on the plural neighboring pixels in the kernel have to be downloaded. In addition, when the kernel scans throughout the two-dimensional image, the same pixel is repeatedly accessed, which is a serious problem.

### SUMMARY OF THE INVENTION

In order to solve the above-described problems, the present invention is achieved, aiming at providing an image processing device and an image processing method to allow image processing without loss using relatively simple combination of equipment, in an extremely short time, and with low power consumption.

As a result of the committed investigation, the inventors have attained following embodiments of the present invention.

The image processing device according to the present invention multiplies two-dimensional pixel data by a matrix of coefficients, and based on a sum of the multiplied results, filters the pixel data. The image processing device at least includes: a memory unit array in which a matrix of plural memory units are arranged, each memory unit having at least a first memory cell, a second memory cell, and a third memory cell to store the above pixel data; first calculators arranged in the number of columns of, and in rows of, the memory unit array, to obtain a first processing data which is obtained by performing computational processing for the pixel data of a certain column in the memory unit array and stored in the second memory cell; and a second calculator arranged in the number of rows of, and in columns of, the memory unit array, to obtain a second processing data by performing computational processing for the pixel data of a certain row in the memory unit array and stored in the third memory cell. The image processing unit carries out the filtering based on a computed result obtained by the second calculator.

An image processing method according to the present invention is an image processing method for the image processing device including the memory unit array in which a plurality memory units to store the pixel data are arranged in a form of matrix, the first calculators which are arranged in the number of columns of, and in rows of, the memory unit array, and the second calculators which are arranged in the number of rows of, and in columns of, the memory unit array. The image processing method includes a first step to obtain the first processing data by performing computational processing for the pixel data in a certain column of the memory unit array, and store the first processing data in the second memory cell which is independent from the first memory cell storing the pixel data in the memory unit, and a second step to obtain the second processing data by performing a computational processing for the first processing data in a certain row of the memory unit, and store the second processing data in the third memory cell in the memory unit.

### BRIEF DESCRIPTION OF THE DRAWINGS

FIG. 1 is a diagrammatic view of an image processing device according to a present embodiment;

FIGS. 2A and 2B are diagrammatic views of an image processing method according to the present embodiment;

FIG. 3 is a diagrammatic view showing a flow of computational processing in a row computation section;

FIG. 4 illustrates a processing method in a Laplacian filter;

FIG. 5 is an equivalent circuit diagram of each memory cell in a memory unit;

FIG. 6 is a diagram of an equivalent circuit of the row computation section and a column computation section; and

FIG. 7 is a diagrammatic view showing a conventional image processing method.

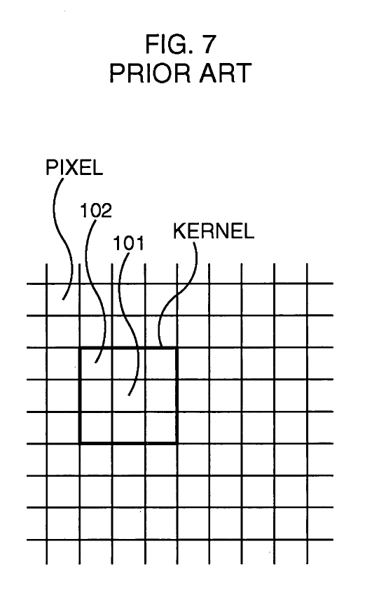

### DETAILED DESCRIPTION OF THE PREFERRED EMBODIMENTS

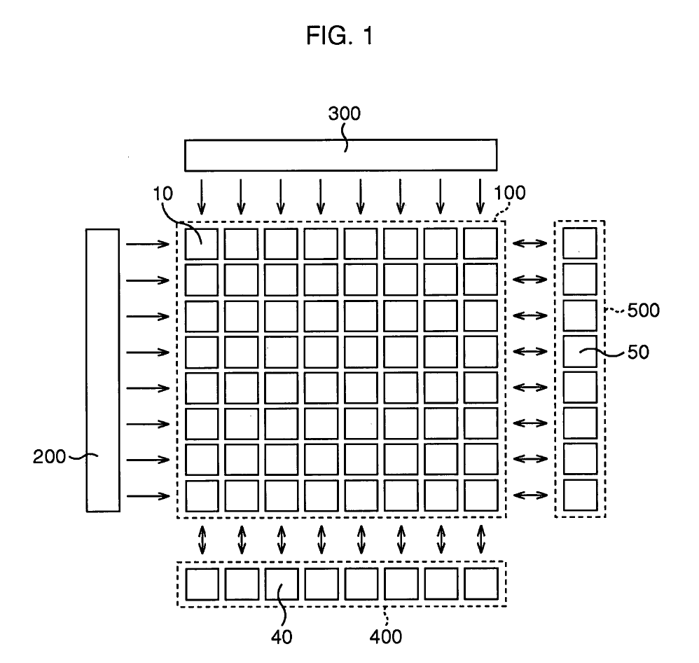

FIG. 1 is a schematic block diagram showing an image processing device in the present embodiment.

The image processing device includes a memory unit array 100 in which memory units 10 having a plurality of memory cells are arranged in a form of matrix, a row selecting section 200 to select a row in the memory unit array 100 from which data is read out, a column selecting section 300 to select a column in the memory unit array 100 from which data is read out, a row computing unit 400 to perform computation of the data in the memory unit 10 selected in the row selecting section 200, and a column computing unit 500 to perform computation of the data in the memory unit 100 selected in the column selecting section 300.

Further, the row computing unit 400 includes row computing sections 40 in the number of columns provided by corresponding to respective columns in the memory unit array 100, in a manner to allow paratactic computation of data from memory units 10 in each row. Similarly, the column computing unit 500 includes column computing sections 50 in the number of rows provided by corresponding to respective rows in the memory unit array 100, in a manner to allow paratactic computation of data from memory units 10 in each column.

The memory unit 10 at least includes, in addition to a first memory cell to store pixel data, a second memory cell to store a first processing data obtained by computation in the row computing unit 400, and a third memory cell to store a second processing data obtained by computation in the column computing unit 500.

The image processing device in the present embodiment combines, upon computation using a matrix of kernel, a computed result in columns and a computed result in rows. By storing the computed results respectively in the first and the second memory cells of the memory unit 10, there is no need to perform computation of each of all necessary pixels.

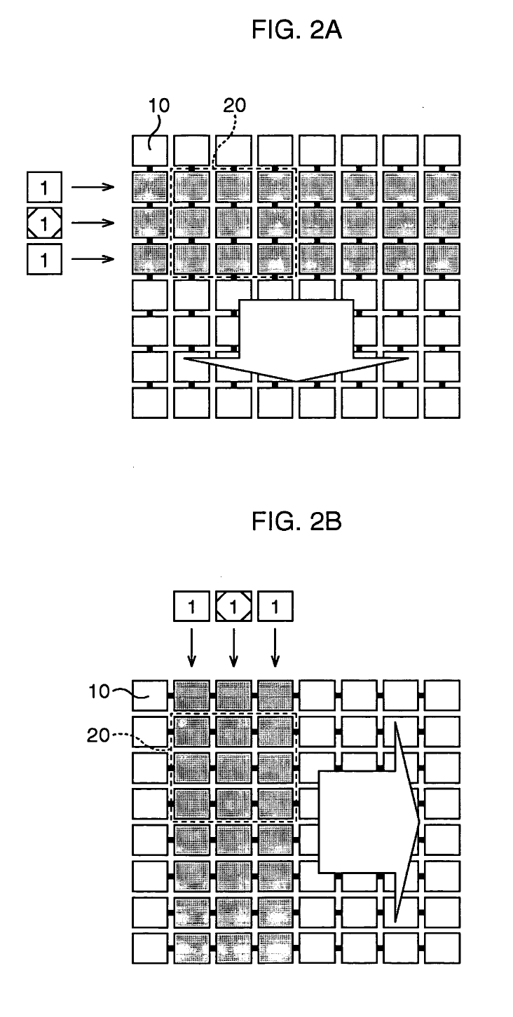

FIGS. 2A and 2B are diagrammatic views showing an image processing method in the present embodiment. As an example of filtering, a smoothing-processing-case is explained below, in which all coefficients forming a 3×3 kernel are “1”.

In FIG. 2A, pixel data stored in the memory units 10 in a row selected in the row selecting section 200 are sequentially read out to the row computing unit 400. Here, each row computing unit 40 performs predetermined computation of three-row pixel data including a middle row selected in the row selecting section 200, and rows above and below that middle row.

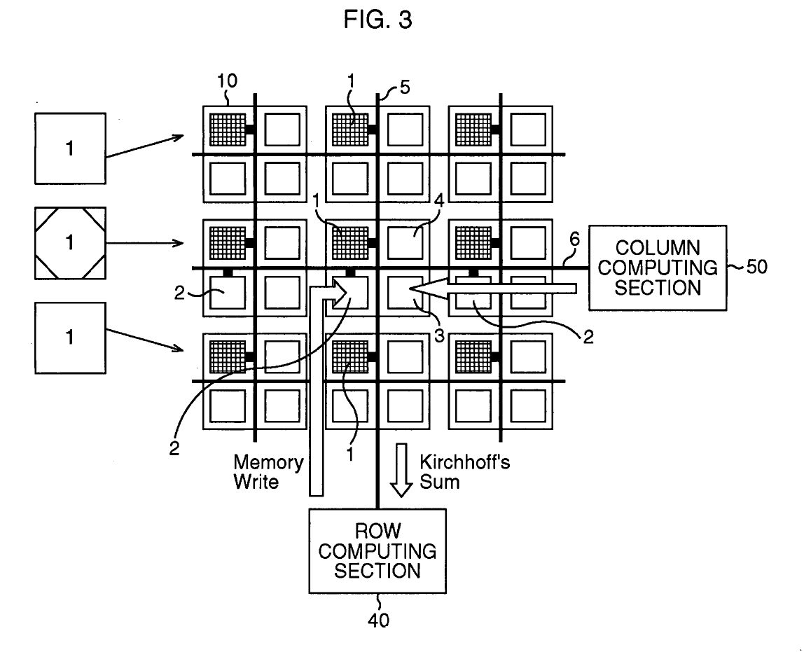

FIG. 3 is a diagrammatic view showing a flow of computational processing in the row computing section 40.

Each memory unit 10 is connected in columns through a column bus 5, and in rows through a row bus 6.

The pixel data stored in the first memory cells 1 are added up as electric current value through the column bus 5 and inputted to the row computing section 40. In the row computing section 40, a computed result obtained by trisecting the total value of the three pixel data in the first memory cells 1 each are stored in the second memory cell 2 in the memory units 10 in the middle row.

Subsequently, as shown in FIG. 2B, the first processing data stored in the second memory cell 2 in the memory units 10 in the column selected by the column selecting section 300 are sequentially read out to the column computing unit 500. Here, each column computing section 50 performs predetermined computation of three-column pixel data including the middle column which is the column selected in the column selecting section 300, and columns on the left and the right thereof.

More specifically, the first processing data stored in the second memory cell 2 of the three memory units 10 in the middle row shown in FIG. 3 are respectively added up as electric current value through the row bus 6, and inputted to the column computing section 50. In the column computing section 50, the computed result obtained by trisecting the total value of the three first processing data of the second memory cells 2 is stored in the third memory cell 3 in the memory units 10 in the middle column.

By performing the above-described processing, the mean value of the pixel data in nine memory units 10 shown in FIG. 3 is stored in the third memory cell 3.

By performing computation for all the rows in the memory unit array 100 by each row computing section 40 of the row computing unit 400, storing the computed results in the memory cell 2 in each memory unit 10, and further performing computation for all the columns in the memory unit array 100 by each column computing section 50 of the column computing unit 500, the computed results are stored in the third memory cell 3 of each of all the memory units 10.

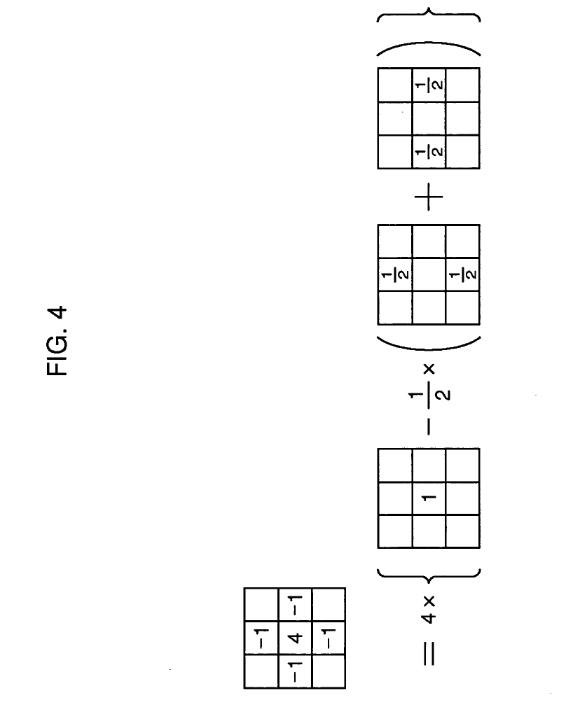

As described above, in the memory unit array 100, computed results in the row computing section 40 and the column computing section 50 respectively are stored in each memory cell of the memory units 10, and by combining the computed results, a complex filtering such as the Laplacian filter shown in FIG. 4 can be realized. Further, when computation in rows and columns of the memory unit array 100 is performed in plural times, the computed result can be stored in a fourth memory cell.

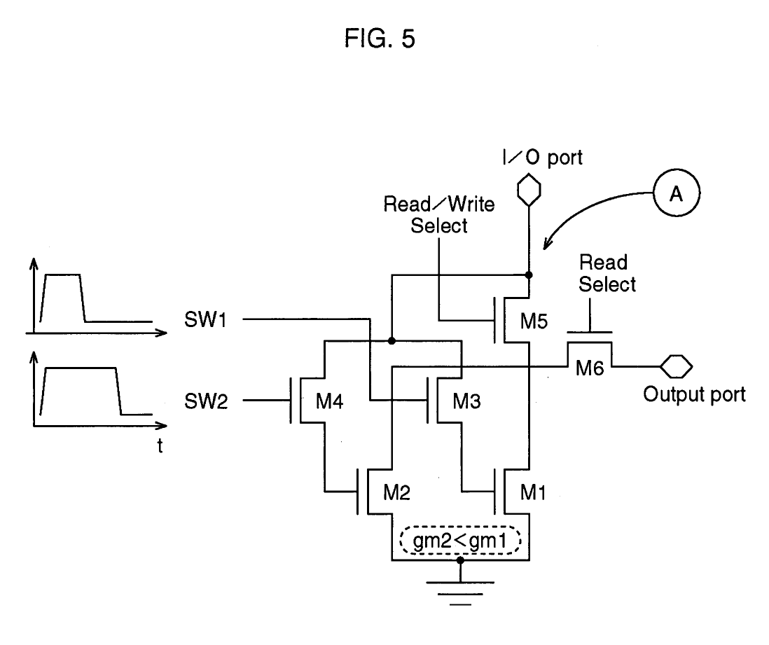

FIG. 5 is an equivalent circuit diagram of each memory cell in a memory unit 10.

As shown in FIG. 5, each memory cell is composed of six transistors (M1 to M6). Each memory cell is provided with two ports, a read/write port (I/O port) and a read-out port (Output port), each of which is connected to either one of the column bus 5 and the row bus 6 shown in FIG. 3. Here, among the four memory cells in the memory unit 10, in two cells the read/write port is connected to column bus 5, and in the remaining two cells the read/write port is connected to the row bus 6.

In the case of writing, the transistors M3, M4, and M5 are turned on such that the total value of the electric current flowing in the transistors M1 and M2 is the pixel data. Further, the transistors M2 and M4 are provided so as to compensate so-called “clock-field-through”.

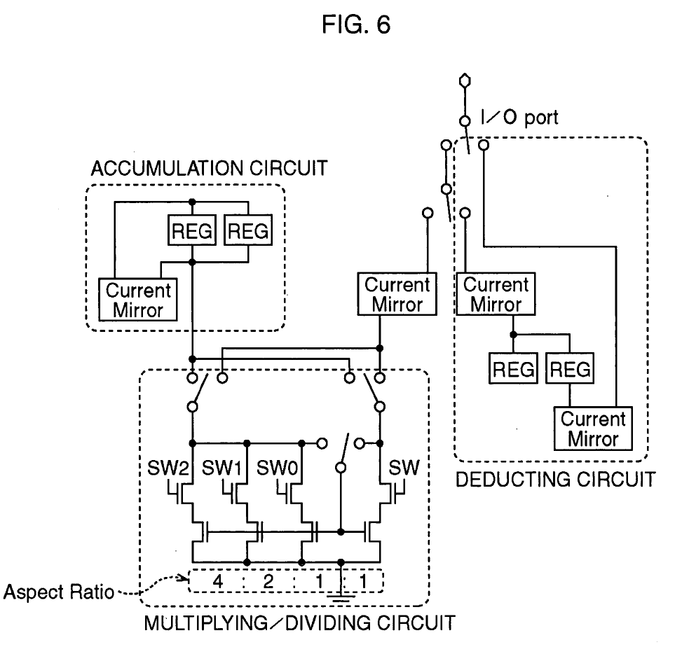

FIG. 6 is an equivalent circuit diagram of the row computing section 40 and the column computing section 50.

Each computing section includes an accumulation circuit, and a multiplying/dividing circuit.

The multiplying circuit is basically a current mirror circuit, and expansion of the gate width of the output-side transistor by one time, twice, or four times, allows multiplication by constant values of one to seven times. Further, the circuit configuration is such that provision of a switch between the accumulation circuit and an output/input terminal allows simultaneous multiplication up to one to 1/7 times.

As has been explained, with the present embodiment, the one-dimensional computation in rows and in columns of the memory unit array 100 does not require a vast volume of computation processing or repeated accesses to a same pixel, so that computation of extremely high efficiency can be performed.

Hence, according to the present embodiment, the image processing device and the image processing method, allowing image processing without loss using relatively simple combination of equipment, in an extremely short time, and with low power consumption, can be provided.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. An image processing device to multiply a two-dimensional pixel data by a matrix of coefficients and filter said pixel data based on a sum of the multiplied results, said image processing device comprising:
a memory unit array in which a plurality of memory units in a form of matrix are arranged which at least includes a first memory cell, a second memory cell and a third memory cell to store said pixel data;
a first calculator arranged in rows of, and in the number of columns of, said memory unit array to perform computation of the pixel data of a specified column in the memory unit array and obtain a first processing data to store in said second memory cell; and
a second calculator arranged in columns of, and in the number of rows of, the memory unit array to perform computation of the first processing data of a specified row of the memory unit array and obtain a second processing data to store in said third memory cell; and
wherein said filtering is performed based on a computed result by the second calculator.

2. The image processing device according to claim 1, wherein said first processing data is stored in a memory unit located in a middle row among said memory units in the specified column, and said second processing data is stored in a memory unit in a middle column among said memory units in the specified row.

3. An image processing method, in an image processing device which comprises:
a memory unit array in which a plurality of memory units to store pixel data are arranged in the form of matrix;
a first calculator arranged in rows of, and in the number of columns of, the memory unit array; and
a second calculator arranged in columns of, and in the number of rows of, the memory unit array; said image processing method comprising:
a first step to obtain a first processing data by performing computation of pixel data in a specified column of the memory unit array to obtain a first processing data, and store the first processing data in a second memory cell which is independent from a first memory cell which stores the pixel data in the memory units; and
a second step to obtain a second processing data by performing computation of said first processing data in a specified row in the memory unit array, and store the second processing data in a third memory cell in the memory units.

4. The image processing method according to claim 3, wherein said first processing data is stored in the memory unit in the middle row among said memory units in the specified column, and said second processing data is stored in the memory unit in the middle column among said memory units in the specified row.

5. The image processing method according to claim 3, wherein computation in said first step is performed by shifting along rows, and subsequently, computation in said second step is performed by shifting along columns.

6. The image processing method according to claim 4, wherein computation in the first step is performed by shifting along rows, and subsequently, computation in the second step is performed by shifting along columns.

7. The image processing method according to claim 3, wherein computation in the second step is performed by shifting along columns, and subsequently, computation in the first step is performed by shifting along rows.

8. The image processing method according to claim 4, wherein computation in the second step is performed by shifting along columns, and subsequently, computation in the fist step is performed by shifting along rows.
